(19) United States
(12) Patent Application Publication
(10) Pub. No.: US 2008/0069648 A1
(43) Pub. Date: Mar. 20, 2008

(54) Thread-whirling tool

(75) Inventor: Mario Macario, Butschwil (CH)

Correspondence Address: SPECKMAN LAW GROUP PLLC, 1201 THIRD AVENUE, SUITE 330, SEATTLE, WA, 98101, US

(73) Assignee: Utilis AG Prazisionswerkzeuge, Mullheim (CH)

(21) Appl. No.: 11/901,762

(22) Filed: Sep. 18, 2007

(30) Foreign Application Priority Data
Sep. 19, 2006 (CH) 01487/06

(51) Int. Cl. B26D 1/12

(52) U.S. Cl. 407/33

(57) ABSTRACT

An annular thread-whirling head is disclosed, wherein, projecting over its periphery, indexable inserts are mounted in recesses in a first plane and are connected directly to the thread-whirling head. The plurality of indexable inserts lies with an indexable insert surface on a bearing surface of the recess, in a manner such that the indexable inserts are individually accessible, and may be assembled and disassembled in a simple manner by way of a fastening element. The produced swarf per indexable insert is minimized by way of the plurality of used indexable inserts, and the service life or the performance of the thread-whirling head is increased. Recesses may also be provided in a second plane so that, apart from a plurality of indexable inserts in a first plane, one may also arrange and fix a plurality of indexable inserts in a second plane, offset parallel to the first plane. A thread-whirling head with indexable inserts in a first and a second plane permits the manufacture of multiplex outer threads in one passage.

### FIELD OF THE INVENTION

The present invention relates to tools for producing threads on, for example, medical implants.

### BACKGROUND OF THE INVENTION

In some technical fields, such as in medical technology, high demands are placed on the production of outer threads by way of a cutting machining of workpiece surfaces. In the field of implants, no sharp edges may arise on cutting the threads, and the resulting thread must be free of burrs and have a high surface quality, which is why threads for implants have been produced by thread-whirling for some time now. Using this method, implants, mostly of rust-free stainless steel, titanium or titanium alloy, may be manufactured with the greatest possible precision.

With this method, a stationary thread-whirling head is rotated at high rotational speeds, fastened on a tool spindle of a lathe, and a workpiece chucked into a tool spindle mostly slowly rotating in the same direction, is led through a through-hole in the thread-whirling head. The workpiece is guided along inserts with a defined number of cutters and cutting edges which project into the through-hole of the thread-whirling head, by which means an outer thread is incorporated into the solid metal by way of the milling of the cutting edges, and may thus be manufactured in one passage (working process).

Various thread shapes may be manufactured, depending on the selection of the profile of the cutters, on the alignment of the thread-whirling head (and thus of the inserts relative to the workpiece), and on the programming of the movement of the workpiece. One may also manufacture tapered threads by way of traveling the workpiece spindle relative to the thread-whirling head, wherein all threads which are manufactured by way of thread-whirling are distinguished by a high quality of the thread surface which is without sharp-edged formations.

A thread-whirling head which is constructed of several rings is described in EP 1 287 932 A1. The thread-whirling head comprises several elongate inserts, which are arranged facing the rotation axis of the thread-whirling head beyond the through-hole of a base. The advantage of the elongate inserts lies in the fact that one may regrind these up to twenty times and accordingly reuse them.

The inserts lie in a plane on the base of the thread-whirling head, and are introduced into slots in a middle ring, which likewise lies on the base. The clamping of an outer ring against the base presses the inserts firmly onto the surface of the base, so that the inserts are fixed on the base in the direction of the rotation axis. The inserted inserts are fixed, lying on the base and lying in the slots of the middle ring, by way of the application of several screws which pass through the outer ring and engage pocket holes in the base.

A threaded pin is inserted for the radial positioning of each individual insert. This pin engages an inner thread in the middle ring, and the setting of the radial distance of each cutting edge of each individual insert is made possible by way of the contact with the side of each insert distant to the cutting edge.

A simple and rapid exchange of individual inserts is not possible, since the inserts are not individually accessible and individually fixed on the base, but are held against the base by way of clamping of the outer ring. The thread-whirling head must be completely disassembled, which entails a greater work effort and a large refitting time. If one or more inserts have been reground, the radial distances of the inserts to the rotation axis must be individually readjusted for each individual insert. This procedure too is time-intensive.

### SUMMARY OF THE INVENTION

The present invention provides an improved thread-whirling head, such that the service life of the thread-whirling head is increased, and the exchange of individual inserts may be carried out in a simple and rapid manner without additional adjustment work.

An annular thread-whirling head is provided which may be fastened on a tool spindle of a lathe and may be rotated about a rotation axis, comprising a through-hole with an inner periphery and a plurality of inserts facing radially in the direction of the rotation axis, comprising at least one cutter with at least one cutting edge, wherein the inserts, projecting radially beyond the inner periphery in the direction of the rotation axis, are arranged such that the at least one cutting edge is guidable on a workpiece in a material-removing manner, said workpiece being mounted on a workpiece spindle, able to be guided in a linearly movable manner within the through-hole, and able to be guided in a rotatably movable manner along the cutters, by which means outer threads of various shapes may be produced in a thread-whirling manner from the solid material of the workpiece.

Further advantageous design forms of the thread-whirling head according to the invention, which further increase the efficiency of thread whirling, are described below.

### BRIEF DESCRIPTION OF THE DRAWINGS

The invention is hereinafter described in combination with the drawings in which:

FIG. 1 shows a perspective view of the thread-whirling head according to the invention, with recesses in a first plane;

FIG. 2 shows a plan view of a thread-whirling head equipped with indexable inserts;

FIG. 3 shows a perspective view of a thread-whirling head with recesses in a first and a second plane; and

FIG. 4 shows a plan view of a thread-whirling head and a tool spindle, partly sectioned in the region of the thread-whirling head.

### DETAILED DESCRIPTION

An annular thread-whirling head 1 according to the invention comprises a through-hole 10 and an inner periphery 11. The thread-whirling head 1 may be fastened with a lathe chuck on a tool spindle 12 of a lathe. During the thread-whirling, the thread-whirling head 1 is rotated at high rotational speeds about a rotation axis 5, which coincides with the cylinder axis of the thread-whirling head 1.

A workpiece spindle 61 on which a workpiece 6 is located, into which an outer thread 60 is milled from the solid material in a thread-whirling a manner, is positioned lying opposite the tool spindle 12. The workpiece spindle 61 rotates about a longitudinal axis 62 of the workpiece 6 at low rotational speeds, and may travel in a linear manner. Computer controlled lathes permit the fully automatic, software-controlled, operation of the entire thread-whirling process, so that the desired outer thread 60 may be carried out in one passage, without any interruption and without further interventions.

A plurality of mirror-symmetrical indexable inserts 3 are arranged distributed along the periphery of the thread-whirling head 1, in a plane 7 in recesses 2 at fixed, defined radial distances to the rotation axis 5. Each individual indexable insert 3 is arranged with an indexable insert surface 32 on a bearing surface 20 of the recess 2, such that a cutter 30 and at least one cutting edge 31 projects over the inner periphery 11 of the thread-whirling head 1 in the direction of the rotation axis 5.

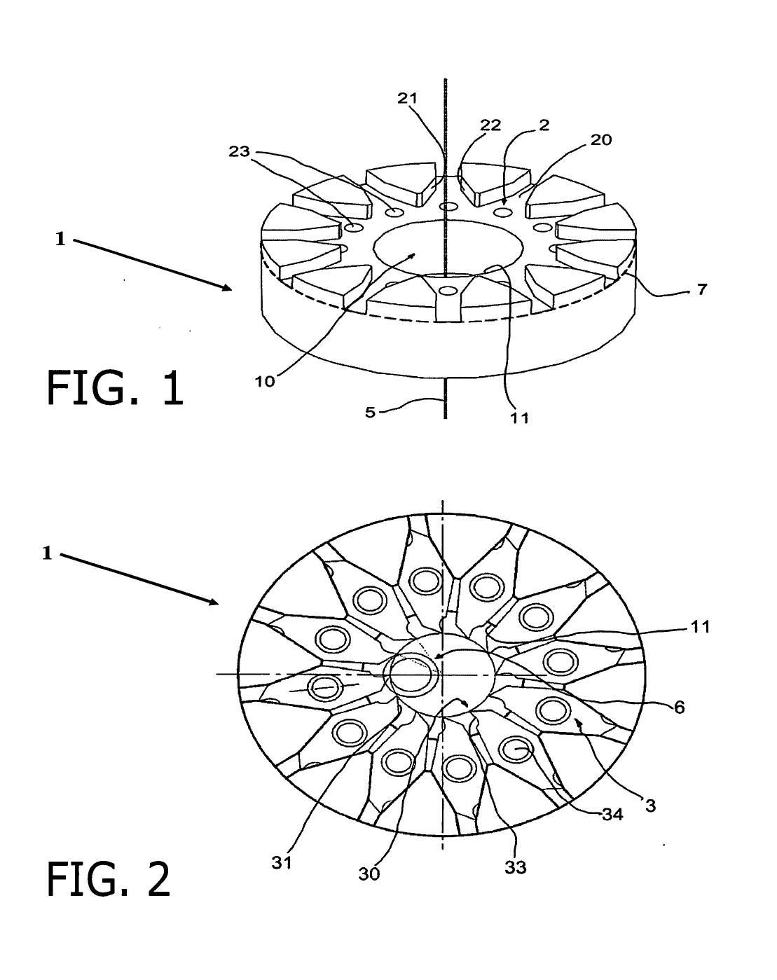

As illustrated in FIG. 1, each individual bearing surface 20 of each individual recess 2 is located in the first plane 7 perpendicular to the rotation axis 5. Each bearing surface 20 is delimited by a first side wall 21 and a second side wall 22, so that the introduced indexable insert 3 is secured against a lateral displacement, and the orientation of the installation of the indexable inserts 3 is defined in a fixed manner by way of the first and second side wall 21. The indexable inserts 3 which are shown here by way of example, are designed in a parallelepiped manner and the section of the recesses 2 must be adapted thereto.

The indexable inserts 2 to be used comprise at least two cutters 30 on opposite sides of the indexable insert 3, wherein each cutter 30 comprises at least one cutting edge 31. One may however also apply indexable inserts 3 which comprise more than one cutting edge 31 per cutter 30. In order to reduce the swarf length at the indexable inserts 3 during the thread-whirling, swarf guiding steps 33 are provided, as is shown in FIG. 2, which lead away the swarf.

The indexable inserts 3 are fixed by fastening elements, which may be screws in one possible embodiment. It is likewise possible for the fastening element to fasten the indexable inserts 3 in the recesses 2 of the thread-whirling head 1 in a clamping manner.

In the embodiment disclosed herein, in each case a screw is led through a threaded bore 23 in each individual bearing surface 20, in each case through a through-hole 34 in each case in the center of an indexable insert 3, and screwed in and countersunk perpendicularly to the bearing surface 20. By way of this, each individual indexable insert 3 is connected with a positive and non-positive fit in each case to one recess, and thus directly connected to the thread-whirling head 1 lying in a first plane 7 perpendicularly to the rotation axis 5.

After chucking a tool 6 into the workpiece spindle 61, the workpiece 6 is rotated at a low rotational speed about its own rotation axis 62, and is introduced into the through-hole 10 of the thread-whirling head 1 by way of linear advance in the direction of the longitudinal axis 62, and is brought into contact with the cutting edges 31 of the thread-whirling head 1 by way of a linear movement perpendicular to the longitudinal axis 62. On thread-whirling, one may select the rotational direction of the tool spindle 12 and the workpiece spindle 61 to be the same or opposite. The cutting contact of the individual cutting edges 31 with the upper surface of the tool 6, and the programmed advance movement and the movement perpendicular to the rotation axis of the thread-whirling head 1, produces an outer thread 60 with a settable nominal diameter 601, core diameter 602 and pitch 603, depending on the desired result.

The individual indexable inserts 3 in a consecutive manner, are only in cutting contact with the workpiece 6 for a brief period, on account of the plurality of indexable inserts 3, by which means less swarf per indexable insert 3 arises, and the loading of each individual indexable insert 3 is reduced. More than one cutting edge 31, possibly even three cutting edges 31 are simultaneously in contact with the workpiece 6, depending on the selection of the desired core diameter 602, by which means the smoothness of running of the lathe may be increased. One may achieve greater performance during the thread-whirling by way of the thread-whirling head 1 according to the invention, by which means the outer thread 60 may be manufactured in short time intervals in one passage. Higher service lives of the thread-whirling head 1 may be achieved by way of the improvements described above.

If individual indexable inserts 3 are worn, due to the current design it is significantly simpler to exchange the individual indexable inserts 3 compared to the state of the art, since these are mounted in the individual recesses 2 in an easily accessible and simply disassemblable manner, whereby the refitting time is minimized. The indexable inserts 3 may be simply removed from the bearing surface 20 between the first side wall 21 and the second side wall, after the respective fastening element has been removed. After the indexing and the re-installation of the indexable insert 3, one requires no orientation and alignment of the indexable inserts 3 on account of the mounting in the described recesses 2.

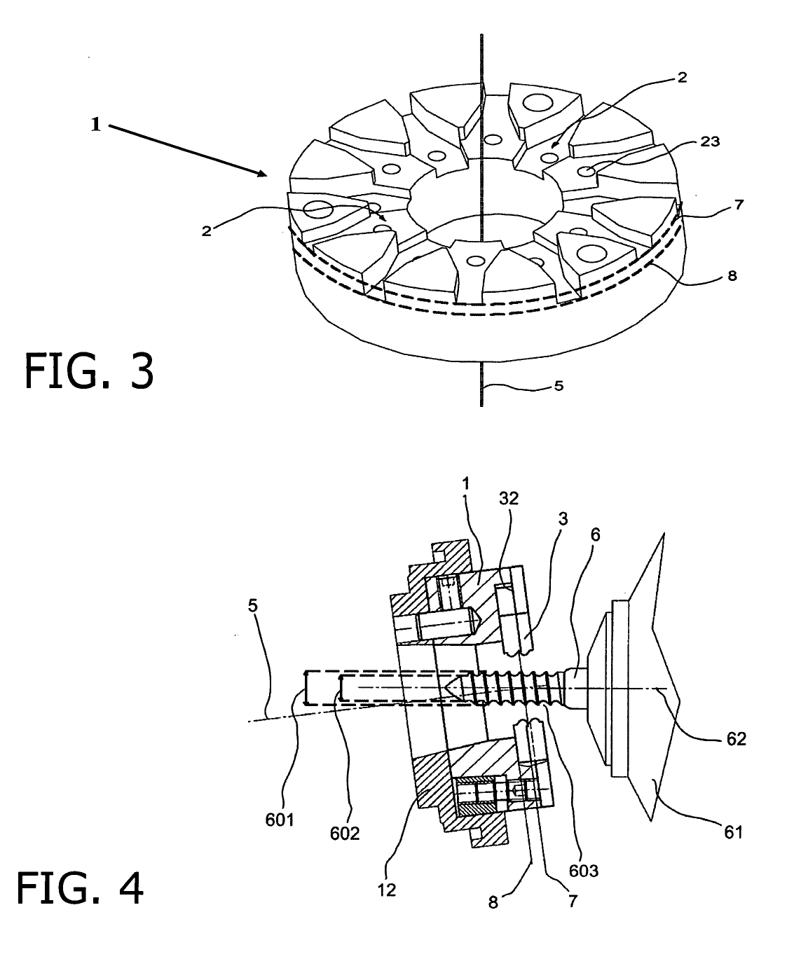

On account of the design, the present invention may be extended to the extent that a plurality of indexable inserts 3 is additionally situated in a second plane 8 perpendicular to the rotation axis 5 and displaced parallel to the first plane 7. A thread-whirling head 1 which comprises recesses 2 in a first plane 7 and in a second plane 8, is disclosed in FIG. 3. The orientation and the direct fixation of the indexable inserts 3 on the thread-whirling head 1 is carried out as has already been described, and also in this case, ensures a simple and quick assembly and disassembly of the indexable inserts 3. It is also possible to produce multiplex outer threads 60 in one passage by way of the thread-whirling head 1 due to the use of indexable inserts 3 in a first 7 and a second plane 8 displaced thereto. The control of the lathe is to be programmed according to the application, so that the advance of the workpiece spindle 61 is adapted to the multiplex outer thread 60 or to the pitch 603 which is to be achieved.

### LIST OF REFERENCE NUMERALS

| | |
|---|---|
| 1 | thread-whirling head |

| | |
|---|---|
| 10 | through-hole (centric) |
| 11 | inner periphery |
| 12 | tool spindle |

| | |
|---|---|
| 2 | recess |

| | |
|---|---|
| 20 | bearing surface |
| 21 | first side wall |
| 22 | second side wall |
| 23 | threaded bore |

| | |
|---|---|
| 3 | indexable insert |

| | |
|---|---|
| 30 | cutter |
| 31 | cutting edge |
| 32 | indexable insert surface |
| 33 | chip guiding step |
| 34 | through-hole |

| | |
|---|---|
| 5 | rotation axis (of the thread-whirling head) |
| 6 | workpiece |

| | |
|---|---|
| 60 | outer thread |

| | |
|---|---|
| 601 | nominal diameter |
| 602 | core diameter |
| 603 | pitch |

| | |
|---|---|
| 61 | workpiece spindle |
| 62 | longitudinal axis |

| | |
|---|---|
| 7 | first plane |
| 8 | second plane |

I claim:

1. An annular thread-whirling head which may be fastened on a tool spindle of a lathe and may be rotated about a rotation axis, comprising a through-hole with an inner periphery and a plurality of inserts facing radially in the direction of the rotation axis, comprising at least one cutter with at least one cutting edge, wherein the inserts, projecting radially beyond the inner periphery in the direction of the rotation axis, are arranged such that the at least one cutting edge is guidable along a workpiece in a material-removing manner, said workpiece being mounted on a workpiece spindle, able to be guided in a linearly movable manner within the through-hole, and able to be guided in a rotatably movable manner along the cutters, by which means outer threads of various shapes may be produced in a thread-whirling manner from the solid material of the workpiece, wherein a plurality of mirror-symmetrical indexable inserts is used, wherein each individual indexable insert may be individually connected directly and with a direct positive and non-positive fit to the thread-whirling head, wherein each indexable insert with an indexable insert surface on a bearing surface of an individual, freely accessible recess, may be mounted in a first plane of the thread-whirling head perpendicularly to the rotation axis, radially orientated between a first side wall and a second side wall of the recess, and may be fixed by way of in each case a fastening element, wherein the distance of the indexable inserts along the periphery of the thread-whirling head is selected such that simultaneously, always more than one cutting edge is in contact with the workpiece.

2. A thread-whirling head according to claim 1, wherein the indexable inserts are rhombic.

3. A thread-whirling head according to claim 1, wherein the indexable inserts have swarf guiding steps in the region of the cutting edge, which simplify the breaking-off and the leading-away of the swarf.

4. A thread-whirling head according to claim 1, wherein the fastening element is a screw which may be screwed perpendicularly, crossing the indexable insert through a through-hole, into a threaded bore in the recess.

5. A thread-whirling head according to claim 1, wherein a plurality of mirror-symmetric indexable inserts directly and with a direct positive-fit and non-positive fit with the thread-whirling head, may be mounted individually in recesses, in a second plane which is arranged perpendicularly to the rotation axis and parallel to the first plane.

6. A thread-whirling head according to claim 5, wherein each individual indexable insert may be mounted with an indexable insert surface on a bearing surface of an individual freely accessible recess, and may be fixed in each case with a fastening element.
